(19) United States
(12) Patent Application Publication
(10) Pub. No.: US 2024/0010022 A1
(43) Pub. Date: Jan. 11, 2024

(54) WALLPAPER SCRAPER

(71) Applicant: Kammerer GmbH, Remchingen (DE)

(72) Inventor: Rolf Kammerer, Remchingen (DE)

(21) Appl. No.: 18/345,273

(22) Filed: Jun. 30, 2023

(30) Foreign Application Priority Data
Jul. 7, 2022 (DE) 10 2022 116 946.4

(51) Int. Cl. B44C 7/02

(52) U.S. Cl. CPC B44C 7/027

(57) ABSTRACT

Disclosed is a wallpaper scraper having a support disc for mounting on a shaft, and a plurality of blades attached to the support disc, each of the blades being held by a clamp.

### RELATED APPLICATIONS

This application claims priority to DE 10 2022 116 946.4, filed Jul. 7, 2022, the entire disclosure of which is hereby incorporated herein by reference.

### BACKGROUND

This disclosure teaches a wallpaper scraper, i.e., a tool for removing wallpaper from walls. This disclosure also teaches an electrical machine that operates with such a wallpaper scraper.

Wallpaper scrapers are known as hand-operated tools. Such wallpaper scrapers have a blade that is attached to a handle. In addition, wallpaper scrapers are also known that are used as tools in electrical machines. An example of such a wallpaper scraper is the “Skil Electric Scraper 7710,” in which an electric motor moves the tool back and forth, thus facilitating the scraping of wallpaper.

### SUMMARY

This disclosure shows a way in which wallpaper residues can be removed more efficiently from a wall using an electric machine and provides a tool for such a machine.

A wallpaper scraper according to this disclosure comprises a carrier disc configured for mounting on a shaft, and a plurality of blades attached to the carrier disc, each of the blades being held by a clamp and thus advantageously being easily replaceable when worn. Such a wallpaper scraper is used as part of a wallpaper scraping machine comprising an electric motor and a shaft driven by the electric motor. In operation, the wallpaper scraper is attached to the shaft of the wallpaper scraper as a replaceable tool and is caused to rotate by the shaft. Rotating blades allow wallpaper residues to be removed at least as well as with commercially available devices that move a blade back and forth linearly.

In particular, it is also advantageous that a wallpaper scraper according to this disclosure can also be used as a tool with a portable grinding machine or other machine, such as a machine for smoothing plaster or concrete that has not yet solidified. Such a grinding machine is disclosed in DE 10 2008 007 520 B4. For this purpose, it is sufficient to mount a wallpaper scraper according to this disclosure on the tool plate driven by a shaft of the portable grinding machine instead of a grinding wheel or the like.

The blades of a wallpaper scraper according to this disclosure can all be held by a common clamp attached to the support disc. However, it is usually better in terms of cost and weight if each blade is held by its own clamp.

An advantageous further refinement of this disclosure provides that each of the blades is clamped between two clamping jaws which are connected to each other by a snap-in connection, preferably by a reversible snap-in connection. A reversible snap-in connection is a snap-in connection that allows reversible separation of the connection. Reversible snap-in connections allow for easy replacement of blades. Snap-in connections are sometimes also called latching connections.

Reversible snap-in or reversible latching connections can be realized by elastically deforming a component of the connection, for example, by bending a snap-in hook out of its snap-in position and thus releasing the snap-in connection. Preferably, the reversible snap-in connection is effected by a resiliently movable bar which carries at least one latching hook and enables unlocking of the connection by pressure on an end portion of the bar, wherein one of the two clamping jaws carries a resiliently movable bar and the other of the two clamping jaws has an opening for insertion of the bar. In this way, blades can be replaced quickly and with little effort, and in particular no tools are required to replace blades.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a top view of a wallpaper scraper according to this disclosure;

FIG. 2 shows an oblique view of the wallpaper scraper;

FIG. 3 shows a side view of the wallpaper scraper;

FIG. 4 shows another side view of the wallpaper scraper; and

FIG. 5 shows a machine for use with the wallpaper scraper.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

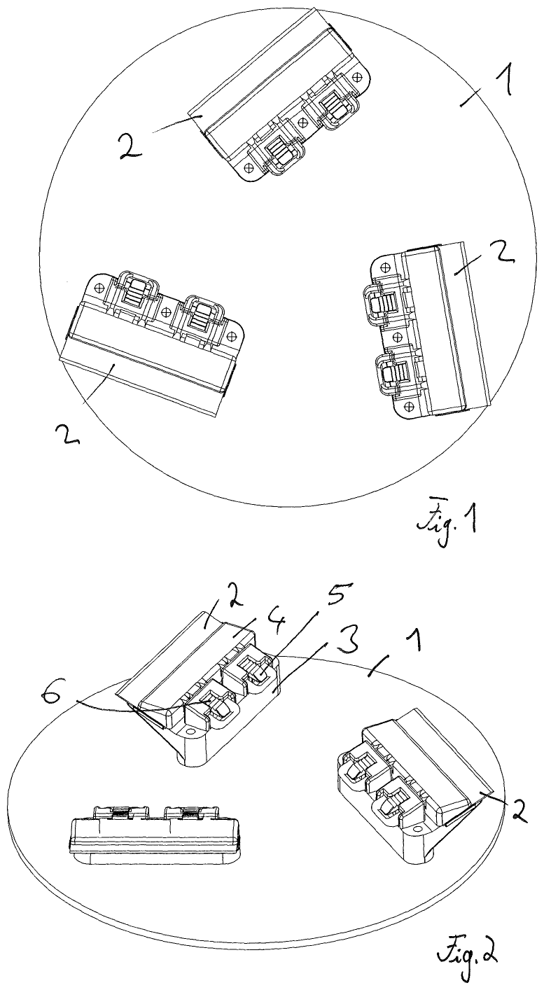

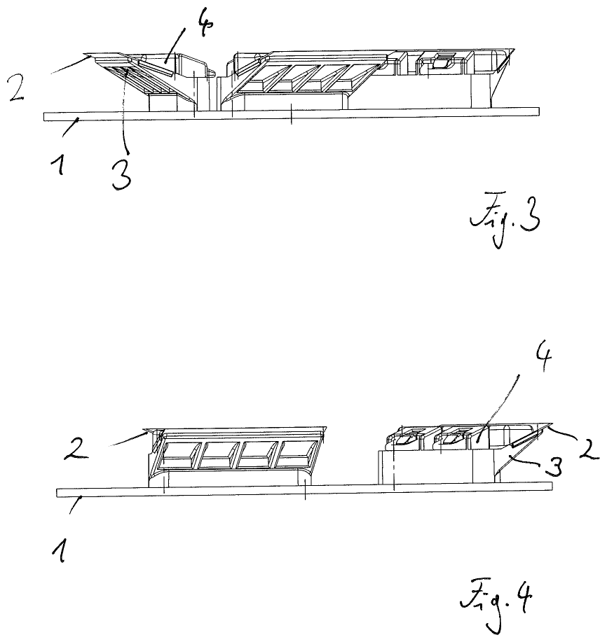

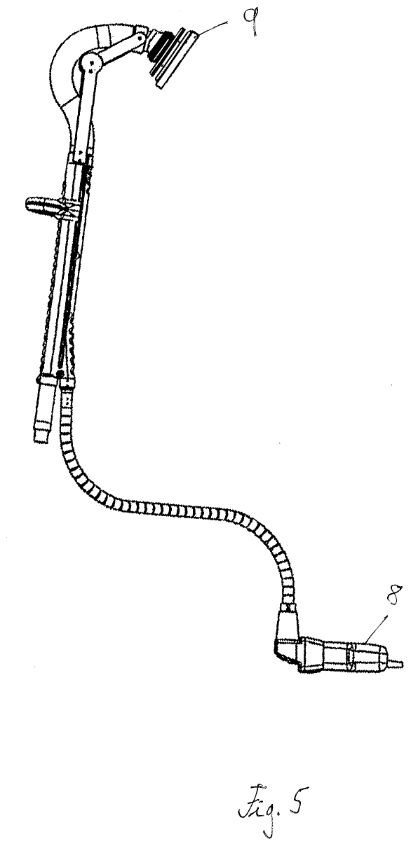

The wallpaper scraper shown in FIGS. 1 to 4 has a carrier disc 1 and several blades 2 attached to the carrier disc, each of which is held by a clamp. The clamps each have two clamping jaws 3, 4 between which the blades 2 are clamped. The first of the two clamping jaws 3 is mounted on the carrier disc 1, for example, by gluing, screwing or riveting. The second clamping jaw 4 is attached to the first clamping jaw 3 by a detachable snap-in connection. It is possible that the blades 2 are held between the clamping jaws 3, 4 exclusively in a force-locking, i.e., clamping manner. However, the blades 2 can also be fastened to the second clamping jaw 4 in order to facilitate the exchange of blades, for example, by adhesive bonding.

The second clamping jaw 4, i.e., the removable clamping jaw, has two or more resiliently movable bars 5 in the embodiment example shown, which carry one or more latching hooks 6. The bar 5 is inserted through an opening in the first clamping jaw 3 attached to the carrier disc 1. In the process, an inner surface of the opening slides over an inclined surface of the latching hook 6 at the front in the direction of insertion. On the rear side in the direction of insertion, the latching hook 6 has a steeper, preferably vertical surface which effects a latching connection. To release the snap-in connection, the free end of the bar 5 can be pressed and the snap-in hook 6 can thus be released from its engagement. In the embodiment shown, the bar 5 carries a plurality of latching hooks 6 arranged in a row one behind the other, similar to a cable tie. In this way, blades 2 of different thicknesses can be used and manufacturing tolerances can be compensated. It is advantageous if the insertion direction encloses an acute angle with a clamping surface, i.e., a surface defined by the held blade 2, for example, an angle between 5° and 15°. In this way, the distance between the two clamping jaws 3, 4 is reduced only slowly during insertion; the reduction of the distance between the two clamping jaws 3, 4 is thus only a fraction of the relative movement of the two clamping jaws 3, 4 in the direction of insertion.

The blades 2 enclose an acute angle with a radial direction, i.e., a plane defined by the carrier disc. Angles between 10° and 25° are favourable, preferably between 20° and 25°.

The carrier disc 1 can have an opening, not shown, in order to be attached to a shaft. It is also possible to attach the carrier disc to a plate of a machine attached to a shaft, for example, with a Velcro fastener.

FIG. 5 shows an electrical machine for using the wallpaper scraper described above as a tool. The machine comprises an electric motor 8 that drives a plate 9 via a flexible shaft. The wallpaper scraper explained above is fixed to the plate 9 of this machine, e.g., by means of Velcro fasteners or a screw. In operation, the motor 8 causes the plate 9 and the wallpaper scraper attached to the plate 9 to rotate and thereby scratch wallpaper from a wall.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SIGNS

1 Carrier disc
2 Blade
3 First clamping jaw
4 Second clamping jaw
5 Bar
6 Snap-in hook
8 Motor
9 Plate

What is claimed is:

1. A wallpaper scraper, comprising:
a support disc configured for mounting on a shaft; and
a plurality of blades attached to the support disc, wherein each of the blades is held by a clamp.

2. The wallpaper scraper according to claim 1, wherein the support disc carries a separate clamp for each of the blades.

3. The wallpaper scraper according to claim 1, wherein the blades enclose an angle of between 10° and 25 with a plane of the support disc.

4. The wallpaper scraper according to claim 1, wherein the blades form an angle of between 20° and 25°, with a plane of the support disc.

5. The wallpaper scraper according to claim 1, wherein each of the blades is clamped between two clamping jaws which are connected to each other by a snap-in connection.

6. The wallpaper scraper according to claim 5, wherein the connection is a reversible latching connection.

7. The wallpaper scraper according to claim 6, wherein the latching connection is effected by a resiliently movable bar which carries one or more latching hooks and enables the latching connection to be unlocked by pressure on an end portion of the bar, wherein one of the two clamping jaws carries a resiliently movable bar and the other of the two clamping jaws has an opening for insertion of the bar.

8. The wallpaper scraper according to claim 7, wherein the opening is a through hole so that an end portion of the bar remains free when the bar is inserted through the opening.

9. The wallpaper scraper according to claim 7, wherein the latching hooks are formed as notches which are bounded on a front side in a direction of insertion by a first surface and on an opposite side by a second surface, the first surface rising more steeply than the second surface.

10. The wallpaper scraper according to claim 9, wherein the direction of insertion and the blade held by the corresponding clamp include an acute angle.

11. The wallpaper scraper according to claim 10, wherein the acute angle is between 5 and 15°.

12. A wallpaper scraping machine comprising a wallpaper scraper according to claim 1, a shaft on which the wallpaper scraper is mounted, and an electric motor for driving the shaft.
